(19) United States
(12) Patent Application Publication
(10) Pub. No.: US 2010/0107468 A1
(43) Pub. Date: May 6, 2010

(54) Measuring rod

(76) Inventors: Roddy Maskrey Padgham, Victor, MT (US); Christopher Neal Chomiak, Hamilton, MT (US)

Correspondence Address: Roddy Maskrey Padgham, 1966 Red Crow Road, Victor, MT, 59875, US

(21) Appl. No.: 12/383,313

(22) Filed: Jun. 8, 2009

Related U.S. Application Data
(60) Provisional application No. 61/197,835, filed on Oct. 31, 2008.

(51) Int. Cl. A01K 97/00

(52) U.S. Cl. 43/25

(57) ABSTRACT

The measuring rod is a measuring system applied graphically to the shaft of an existing fishing rod blank, in U.S. standard inches or alternatively metrics. that allows the fisherman to measure the length of his catch. The measuring system starts at the base of the fishing rod above the handle and goes up to four feet of the length of the fishing rod shaft. The measuring system has numerical indicators at every six inch interval.

The measuring rod is simply a measuring system commercially applied by graphic method to the base of an existing fishing rod blank, (either graphite, fiberglass, wood, bamboo, plastic fishing rod blanks) in standard measure u.s. inches (s.a.e.) or alternatively, metric equivalent, that allows the fisherman to measure the length of his catch.

Graphically, the measuring system is applied to the fishing rod blank by either silkscreen method, (using waterproof polymer paints or polymer inks) laser etching method, mechanical airbrush, commercial industrial grade decal.

The measuring system starts from the top of the fishing rod handle where the fishing rod shaft begins and extends to four feet up the fishing rod shaft.

The measuring system is applied to either standard commercially made fishing rods (saltwater and fresh-water fishing rods) or fly fishing rods (saltwater and freshwater fly fishing rods) of any composition including graphite, fiberglass, wood, bamboo, plastic.

### BRIEF DESCRIPTION OF VIEWS OF DRAWING

FIG. 1 is a partial view of the measuring system on a fishing rod. The measuring system starts at the base of the fishing rod handle and extends up to a maximum of four feet up the fishing rod shaft. The measuring system has numerical indicators at every six inch interval.

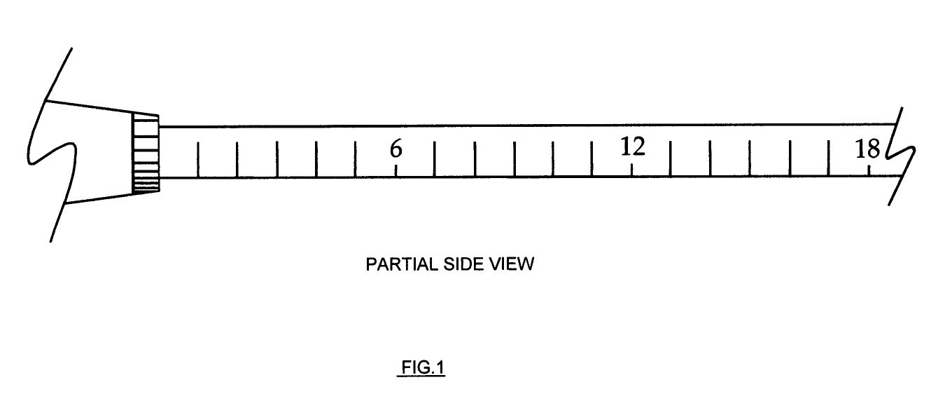

Claim: The invention is original since no other form of measuring devices have been applied to commercially made fishing rods and subsequently patented as of this date. we are the first to patent the idea of a fishing rod measuring device using application techniques of either silkscreen with polymer paints or inks, laser etching method, airbrush, or decal. The measuring system starts at the base of the fishing rod above the handle and goes up to four feet of the length of the fishing rod shaft. The measuring system has numerical indicators at every six inch interal.

1. The invention is original since no other form of measuring devices have been applied to commercially made fishing rods and currently patented as of this date. We are the first to patent the idea of a fishing rod measuring device using application techniques of either silkscreen with polymer paints or inks, laser etching method, airbrush or decal. The measuring system starts at the base of the fishing rod above the handle and goes up to four feet of the length of the fishing rod shaft. The measuring system has numerical indicators at every six inch interval.
